(19) United States
(12) Patent Application Publication
(10) Pub. No.: US 2009/0225052 A1
(43) Pub. Date: Sep. 10, 2009

(54) INPUT DEVICE

(75) Inventor: Chia-Hung Liu, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 12/399,053

(22) Filed: Mar. 6, 2009

(30) Foreign Application Priority Data
Mar. 6, 2008 (TW) 97107955

(51) Int. Cl. G06F 3/041

(52) U.S. Cl. 345/173

(57) ABSTRACT

An input device is provided. The input device includes a base, a keyboard structure, a touch panel, a press-sensing element and a control unit. The keyboard structure is disposed above the base. The touch panel moving relative to the base upward and downward is disposed above the base. When the touch panel is touched by an object, the touch panel generates a touching signal. The press-sensing element is disposed between the base and the touch panel. When the press-sensing element senses that the touch panel is pressed by the object, the press-sensing element generates a pressing signal. At the time that the control unit receives the pressing signal, the control unit performs a first action or a second action according to the content of the touching signal being received.

This application claims the benefit of Taiwan application Serial No. 97107955, filed Mar. 6, 2008, the subject matter of which is incorporated herein by reference.

### BACKGROUND OF THE INVENTION

1. Field of the Invention

The invention relates in general to an input device, and more particularly to an input device with touch control function.

2. Description of the Related Art

Nowadays, most electronic devices have an input interface for the user to operate with. Examples of the interface include keyboard, mouse, key set and touch panel. The user operates the built-in software of the electronic device to capture data, input data₁ communicate with other electronic device or get connected to the Internet by the interface.

Currently, the most popular input method is implemented by a keyboard accompanied by a mouse or a keyboard accompanied by a touch panel. As the keyboard and the mouse are two different entities, when the user types via the keyboard, if the user would like to move the cursor on the screen, the user's one hand has to move to the mouse from the keyboard. During long duration of use, the user may find the reciprocal movements troublesome. Several function keys disposed on the keyboard for the user's convenience. In addition to the most commonly seen function keys such as window key, control key and function key (such as F1, F2), examples of the hot keys further include website hot key and volume key. Besides, the input interface has several fast keys on the keyboard for the user's convenience of operation. However, the above method does not do the user too much good. Let the fast key be taken for example. The user has to remember many key combinations, and this method is difficult to those who are not skilled in operating the key combinations. Thus, how to make the input device more user-friendly more humanized and smoother in use has become an imminent goal to achieve.

### SUMMARY OF THE INVENTION

The invention is directed to an input device, a first action or a second action are performed according to the content of a touching signal being received, so that a keyboard can perform two different actions, saving user's trouble during operation.

According to a first aspect of the present invention, an input device is provided. The input device includes a base, a keyboard structure, a touch panel, a press-sensing element and a control unit. The keyboard structure is disposed above the base. The touch panel moving relative to the base upward and downward is disposed above the base. When the touch panel is touched by an object, the touch panel generates a touching signal. The press-sensing element is disposed between the base and the touch panel. When the press-sensing element senses that the touch panel is pressed by the object, the press-sensing element generates a pressing signal. At the time that the control unit receives the pressing signal, the control unit performs a first action or a second action according to the content of the touching signal being received.

According to a second aspect of the present invention, an input device including a base, a plurality of keys and a touch panel is provided. The keys are disposed above the base. The touch panel is disposed above the base and located among the keys.

According to a third aspect of the present invention, an input device including a keyboard and a touch panel is provided. The keyboard includes a base. The touch panel is disposed at a part of the base.

The invention will become apparent from the following detailed description of the preferred but non-limiting embodiments. The following description is made with reference to the accompanying drawings.

### BRIEF DESCRIPTION OF THE DRAWINGS

FIG. 1A shows a top view of an input device according to a first embodiment of the invention;

FIG. 1B shows a cross-sectional view along a cross-sectional line 1B-1B′ of FIG. 1A;

FIG. 2 shows a first action drove by an object which touches or presses a touch panel according to a first embodiment of the invention;

FIG. 3 shows a screen corresponding to the first action shown in FIG. 2;

FIG. 4 shows a second action drove by an object which touches or presses a touch panel according to a first embodiment of the invention;

FIG. 5 shows a screen corresponding to the second action shown in FIG. 4;

FIG. 6 shows a cross-sectional view of an input device according to a second embodiment of the invention;

FIG. 7A shows a top view of an input device according to a third embodiment of the invention;

FIG. 7B shows a cross-sectional view along a cross-sectional line 7B-7B′ of FIG. 7A;

FIG. 8 shows a cross-sectional view of an input device according to a fourth embodiment of the invention;

FIG. 9 shows a top view of an input device according to a fifth embodiment of the invention;

FIG. 10 shows a top view of an input device according to a sixth embodiment of the invention; and

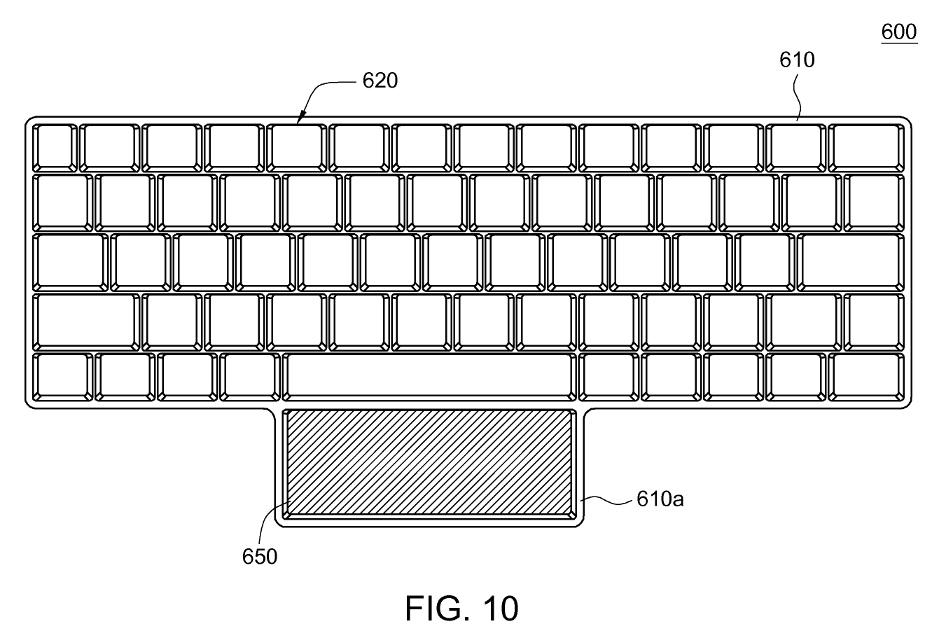

FIG. 11 shows a top view of an input device according to a seventh embodiment of the invention.

### DETAILED DESCRIPTION OF THE INVENTION

### First Embodiment

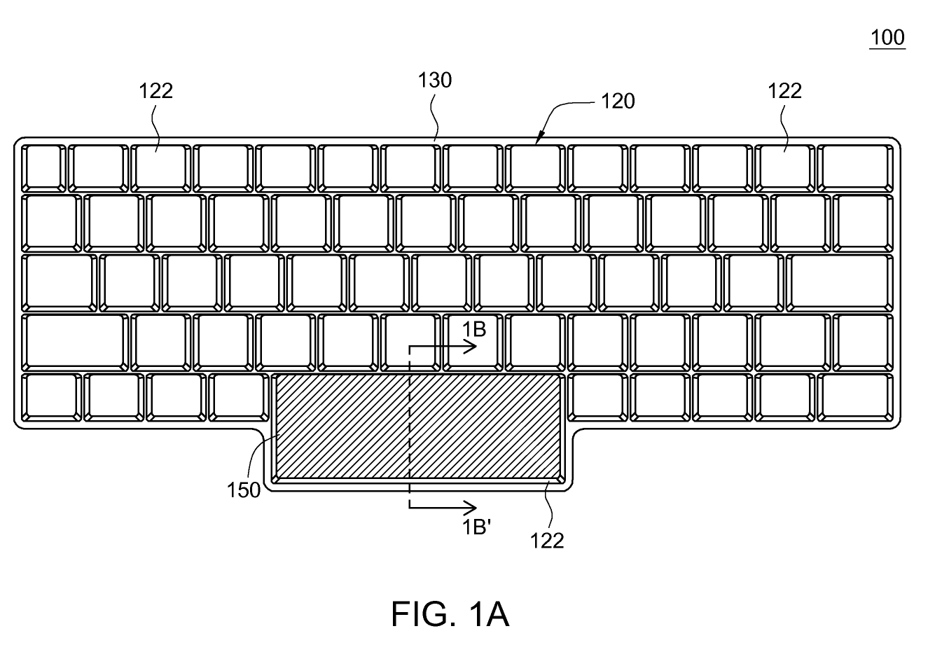

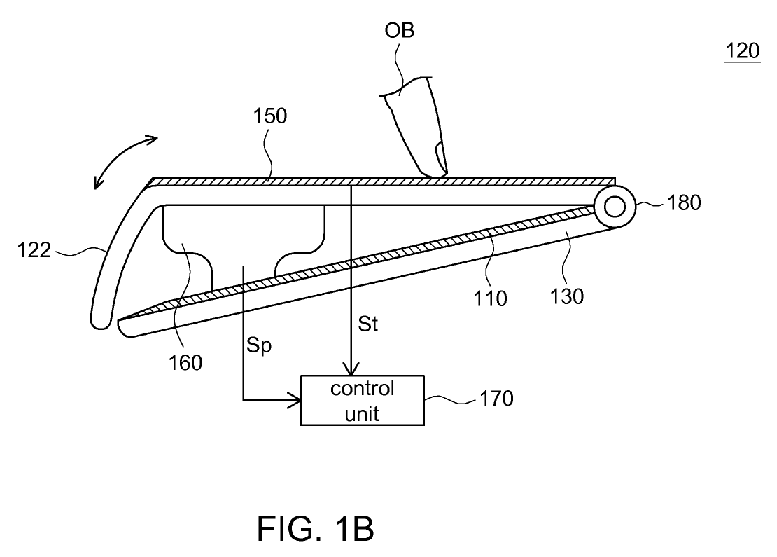

Referring to FIG. 1A and FIG. 1B at the same time. FIG. 1A shows a top view of an input device according to a first embodiment of the invention. FIG. 1B shows a cross-sectional view along a cross-sectional line 1B-1B′ of FIG. 1A. The input device 100 includes a base 130, a keyboard structure 120, a touch panel 150, a press-sensing element 160 and a control unit 170. The keyboard structures 120 are disposed above the base 130. The touch panel 150 is disposed above the base 130. When the touch panel 150 is touched by an object OB, the touch panel 150 generates a touching signal St. The press-sensing element 160 is disposed between the base 130 and the touch panel 150. When the press-sensing element 160 senses that the touch panel 150 is touched by the object OB, the press-sensing element 160 generates a pressing signal Sp. At the time that the control unit 170 receives the pressing signal Sp, the control unit 170 performs a first action or a second action according to the content of the touching signal St being received.

In the present embodiment of the invention, the keyboard structure 120 includes a plurality of keys 122. The touch panel 150 is disposed on one of the keys. In the present embodiment of the invention, the touch panel 150 can be disposed on the space key of the keyboard structure 120, the enter key, or any key 122 of the keyboard structure 120.

In the present embodiment of the invention, the keyboard structure 120 preferably further includes a circuit board 110 and a plurality of pivot 180. The circuit board 110 is disposed on the base 130, which is used for supporting the circuit board 110. The pivots 180 correspond to a plurality of keys 122. Each pivot 180 is disposed on the base 130 and connected to one end of a corresponding key 122. Thus, each key 122 swings relatively to the base 130 upward and downward around the pivot 180. At the time that the touch panel 150 disposed on the key 122 is pressed by the object OB, the key 122 and the touch panel 150 swing relatively to the base 130 upward and downward around the pivot 180, and the press-sensing element 160 generates the pressing signal Sp. The press-sensing element 160 of the present embodiment of the invention is an elastomer for example. When the object OB presses the key 122 and the touch panel 150, the elastomer is squeezed by an external force and activates the circuit board 110 to generate a pressing signal Sp. Besides, the press-sensing element 160 is not limited to an elastomer, and a stage switch, a touch switch or a micro switch would also do.

Referring to FIG. 1B. In the present embodiment of the invention, the content of the touching signal St includes a moving distance for which the object OB is moved on the touch panel 150 within a predetermined time. The control unit 170 performs the first action or the second action according to the content of the touching signal St. The control unit 170, according to the content of the touching signal St, determines whether the moving distance for which the object OB is moved on the touch panel 150 within the predetermined time is larger than a predetermined distance. If yes, the control unit 170 performs the first action; otherwise the control unit 170 performs the second action. Thus, the control unit 170 can recognize whether the object OB indicates the first action or the second action on the touch panel 150. In the present embodiment of the invention, the first action, for example, is clicking and is equivalent to the action of pressing the touch panel 150, and the second action, for example, is keying in and is equivalent to the action of pressing the keyboard key.

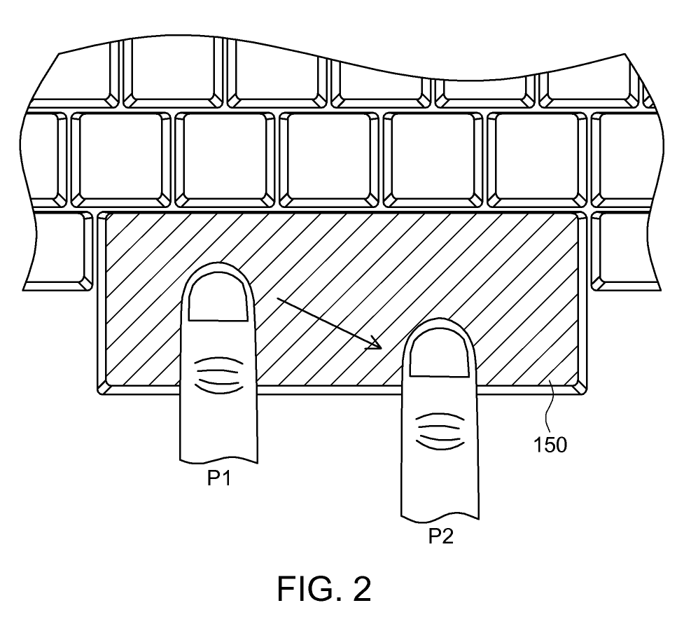

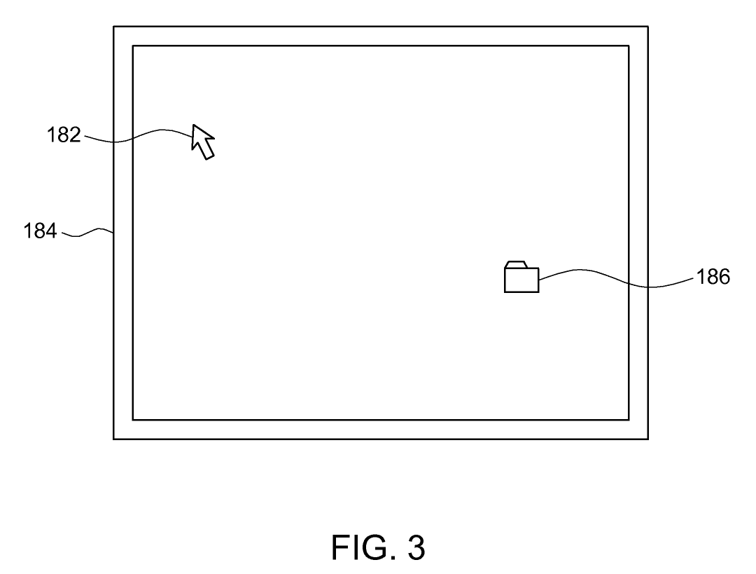

A practical example is disclosed below for elaborating the operation of the input device 100. The object OB is exemplified by a user's finger. Referring to FIG. 2 and FIG. 3. FIG. 2 shows a first action drove by the object which touches or presses the touch panel according to the first embodiment of the invention. FIG. 3 shows a screen corresponding to the first action shown in FIG. 2. In the present embodiment of the invention, the predetermined time is exemplified by 1 second, and predetermined distance is 0.5 cm for example. In order to perform the action of clicking a file holder 186 with a cursor 182 of FIG. 3 when the user's finger is located at a first position P1 of FIG. 2, the user's finger will slide on the touch panel 150 to control the cursor 182 of the screen 184 so as to move the cursor 182 to the file holder 186. Next, the touch panel 150 is pressed to perform the action of clicking. Thus, the moving distance for which the finger is moved within a predetermined time, that is, 1 second, substantially is larger than a predetermined distance, that is, 0.5 cm, and the touch panel 150 is pressed for enabling the press-sensing element 160 to send the pressing signal Sp to the control unit 170. According to the content of the touching signal St, if the moving distance for which the finger is moved on the touch panel 150 within the predetermined time is larger than the predetermined distance, the control unit 170 performs the first action.

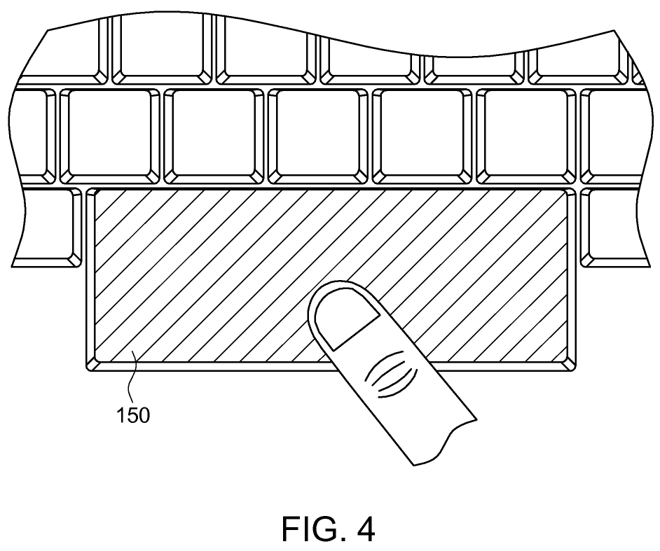

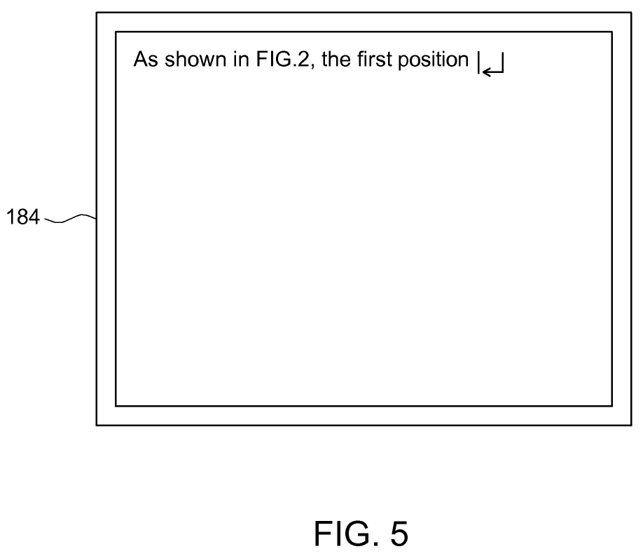

Referring to FIG. 4 and FIG. 5. FIG. 4 shows a second action drove by the object which touches or presses the touch panel according to the first embodiment of the invention. FIG. 5 shows a screen corresponding to the second action shown in FIG. 4. When the user would like to input a space by pressing the space key, the finger directly presses the touch panel 150 for enabling the press-sensing element 160 to send a pressing signal Sp to the control unit 170. Thus, the finger will not move for more than 0.5 cm within the predetermined time, that is, 1 second. According to the content of the pressing signal Sp, the control unit 170 performs the second action.

To summarize, in the present embodiment of the invention, the control unit 170 determines whether the pressing signal Sp to be performed is the first action or the second action according to the content of the pressing signal Sp. Thus, if the user would like to use the cursor in the manner of using a mouse, then the user can control the cursor by pressing and moving the cursor on the touch panel 150 like what the conventional practice would do. If the user would like to input in the manner of using a keyboard, that is, the user uses the touch panel 150 as a keyboard and inputs the data via the touch panel 150, then the control unit 170 of the present embodiment of the invention will automatically determine the action to be performed by the user according to the content of the touching signal St. Thus, the user can perform the action of clicking or keying in by way of pressing and moving on the touch panel 150 of the present embodiment of the invention. When using a computer, the user does not have to move his finger between the keyboard and the mouse reciprocally, not only saving the user a lot of troubles but also increasing the convenience in operating the keyboard. Besides, the predetermined time and the predetermined distance exemplified in the present embodiment of the invention can be adjusted according to the sensitivity of the touch panel 150, the user's habits and reference, and actually needs. For example, for a touch panel 150 with high sensitivity, the predetermined distance can be increased to avoid the control unit 170 making incorrect judgments due to high sensitivity.

### Second Embodiment

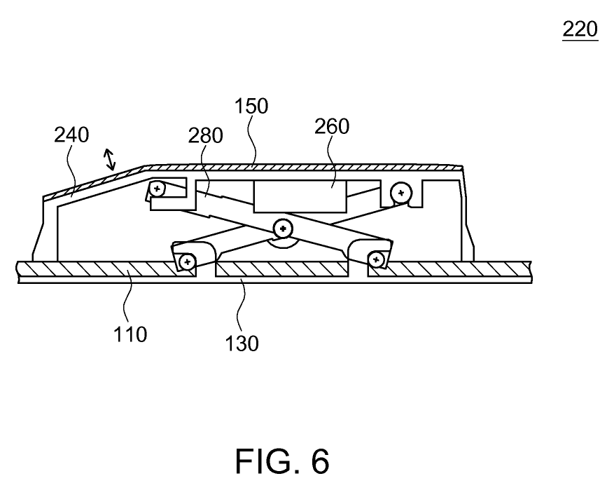

Referring to FIG. 6, a cross-sectional view of an input device according to a second embodiment of the invention is shown. The keyboard structure 220 of the second embodiment moves the keys 240 upward and downward by way of a bar linkage 280. The second embodiment differs with the first embodiment in the mechanism of moving the key 240 upward and downward when the key 240 is pressed, and other similarities are not repeated here.

In the present embodiment of the invention, the keyboard structure 220 preferably includes a plurality of keys 240 and a bar linkage 280. Only a key 240 and a bar linkage 280 are illustrated in FIG. 6. The bar linkage 280 is disposed between the base 130 and key 240. The bar linkage 280 includes two rods coupled to each other, wherein one end of each rod is coupled to the base 130, and the other end of each rod is disposed on the bottom surface of the key 240. Thus, each key 240 can move relatively to the base 130 upward and downward by way of the bar linkage 280. In the present embodiment of the invention, when the touch panel 150 located on the key 240 is pressed by the object OB (shown in FIG. 1B), the touch panel 150 moves relatively to the base 130 upward and downward by way of the bar linkage 280. Thus, when the touch panel 150 is pressed by the object OB, the press-sensing element 260 moves downward to activate the circuit board 110 to generate the pressing signal Sp (Shown in FIG. 1B).

### Third Embodiment

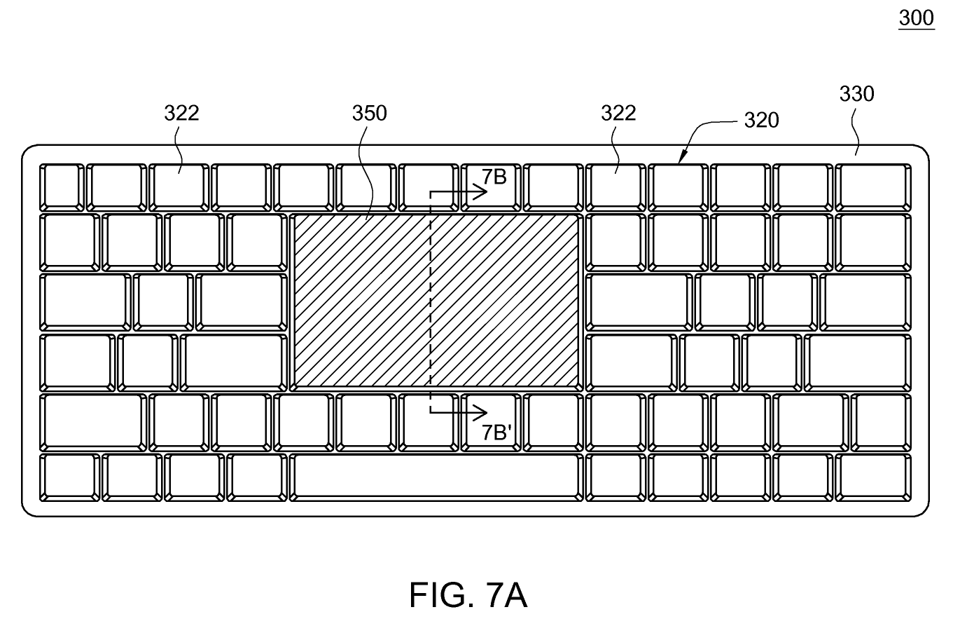

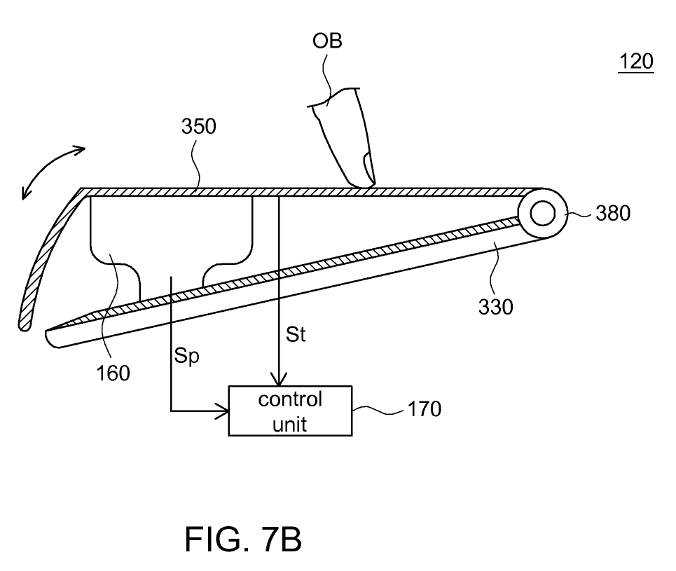

Referring to at the same time FIG. 7A and FIG. 7B. FIG. 7A shows a top view of an input device according to a third embodiment of the invention. FIG. 7B shows a cross-sectional view along a cross-sectional line 7B-7B′ of FIG. 7A. The touch panel 350 of the third embodiment is disposed among a plurality of keys 322 of the keyboard structure 320. The third embodiment differs with the first embodiment in the design of disposing the touch panel 350, and other similarities are not repeated here.

The input device 300 includes a base 330, a keyboard structure 320, a touch panel 350, a press-sensing element 160 and a control unit 170. The keyboard structures 320 are disposed above the base 330. The touch panel 350, moving relatively to the base 330 upward and downward, is disposed above the base 330. When the touch panel 350 is touched by an object OB, the touch panel 350 generates a touching signal St. The press-sensing element 160 is disposed between the base 330 and the touch panel 350. When the press-sensing element 160 senses that the touch panel 350 is pressed by the object OB, the press-sensing element 160 generates a pressing signal Sp. At the time that the control unit 170 receives the pressing signal Sp, the control unit 170 performs a first action or a second action according to the content of the touching signal St being received.

In the present embodiment of the invention, the keyboard structure 320 includes a plurality of keys 322, wherein the touch panel 350 is disposed above the base 330 and located among the keys 322. The touch panel 350, for example, is disposed in the middle of the keyboard structure 120 and located among the keys 322 but is not limited thereto. The actual arrangement of the keys 322 and the touch panel 350 are determined according to actual needs.

In the present embodiment of the invention, the input device 300 further includes a pivot 380 which is disposed on the base 330 and connected to one end of the touch panel 350. Thus, the touch panel 350 swings relatively to the base 330 upward and downward around the pivot 380. When the touch panel 350 of the present embodiment of the invention is pressed by the object OB, the touch panel 350 swings relatively to the base 330 upward and downward around the pivot 380, so that the press-sensing element 160 generates the pressing signal Sp.

As disclosed above, the control unit 170 determines whether to perform the first action or the second action according to the content of the touching signal St. In the present embodiment of the invention, the first action, for example, is the action of clicking, and the second action, for example, is the action of keying in. Thus, the touch panel 350 has the conventional inputting functions of clicking the touch panel 350 and keying in, and the user can perform the function of clicking the cursor or keying in by way of the touch panel 350 of the present embodiment of the invention.

As the touch panel 350 of the present embodiment of the invention is located at the center of the keyboard structure, the touch panel 350 can also be used as any key at the center of a conventional keyboard structure such as the key H or the key G. However, the position of the touch panel 350 is not subjected to any specific restriction, and the position of the tpuch panel 350 panel 350 and the key being disposed thereabove can be adjusted according to the user's habits.

### Fourth Embodiment

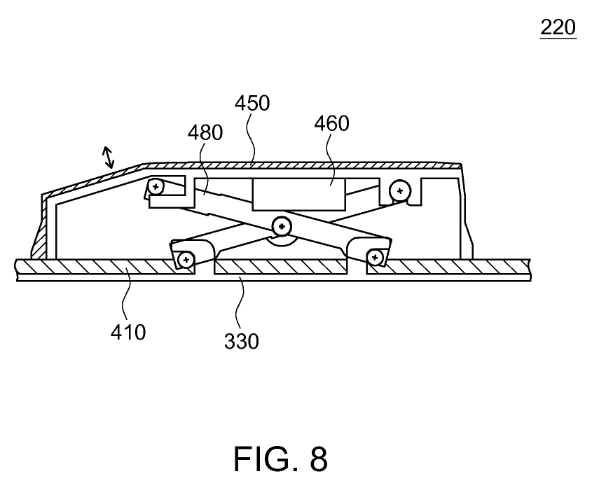

Referring to FIG. 8, a cross-sectional view of an input device according to a fourth embodiment of the invention is shown. The touch panel 450 of the fourth embodiment moves the touch panel 450 upward and downward by way of a bar linkage 480. The fourth embodiment differs with the third embodiment in the mechanism of moving the touch panel 450 upward and downward when the touch panel 450 is pressed, and other similarities are not repeated here.

In the present embodiment of the invention, the input device preferably further includes a bar linkage 480. Only a touch panel 450 and a bar linkage 480 are illustrated in FIG. 8. The bar linkage 480 is disposed on the base 330 and the touch panel 450. The bar linkage 480 includes two rods coupled to each other, wherein one end of each rod is coupled to the base 330, and the other end of each rod is disposed on the bottom surface of the touch panel 450. Thus, the touch panel 450 can move relatively to the base 330 upward and downward by way of the bar linkage 480. When the touch panel 450 of the present embodiment of the invention is pressed by the object OB (shown in FIG. 1B), the touch panel 450 moves relatively to the base 330 upward and downward by way of the bar linkage 480. Thus, at the time when the object OB is pressed, the press-sensing element 460 moves downward to activate the circuit board 410 to generate the pressing signal Sp (shown in FIG. 1B).

### Fifth Embodiment

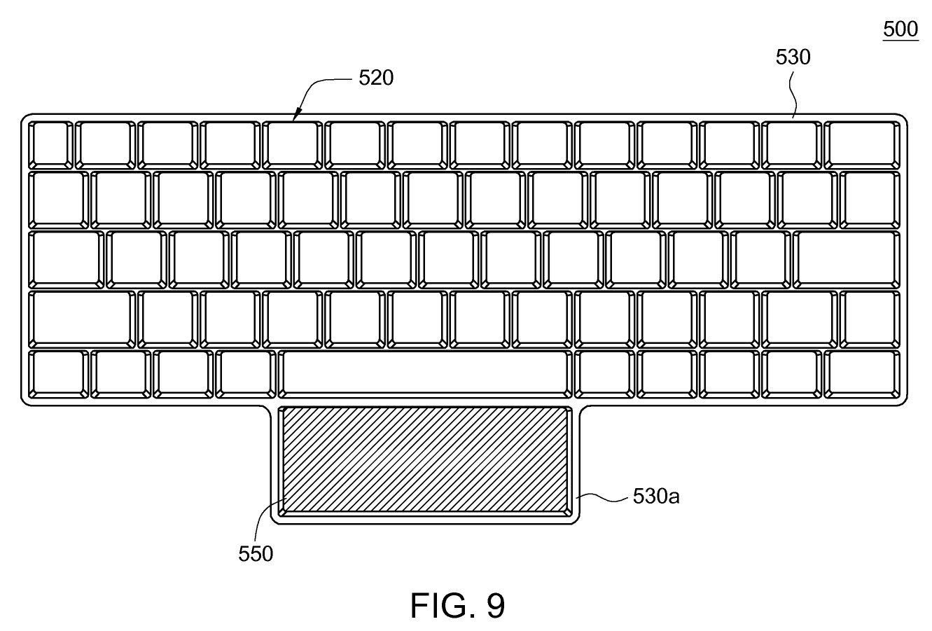

Referring to FIG. 9, a top view of an input device according to a fifth embodiment of the invention is shown. According to the input device 500 of the fifth embodiment, the touch panel 550 is disposed at a part of the base 530 of the keyboard structure 520. The fifth embodiment differs with the third embodiment in the design of disposing the touch panel 550, and other similarities are not repeated here.

In the present embodiment of the invention, the input device 500 includes a keyboard structure 520 and a touch panel 550. The keyboard structure 520 includes a base 530. The touch panel 550 is disposed at a part of the base 530.

Besides, the base 530 of the present embodiment of the invention includes an extension portion 530a on which the touch panel 550 is disposed.

### Sixth Embodiment

Referring to FIG. 1 0, a top view of an input device according to a sixth embodiment of the invention is shown. The input device 600 includes a keyboard structure 620 and a touch panel 650. The keyboard structure 620 includes a base 610, and the touch panel 650 is disposed at a part of the base 610. The base 610 includes an extension portion 610a on which the touch panel 650 is disposed. Thus, the user can directly operate the touch panel 650 on the input device 600 without having to move between the input device 600 and the mouse reciprocally, saving the user's trouble in use and increasing the convenience of operation. Besides, as the touch panel 650 and the key 620 are disposed above the same base 610, the touch panel 650 does not need to be disposed above another base, hence effectively saving the manufacturing cost of the input device 600.

### Seventh Embodiment

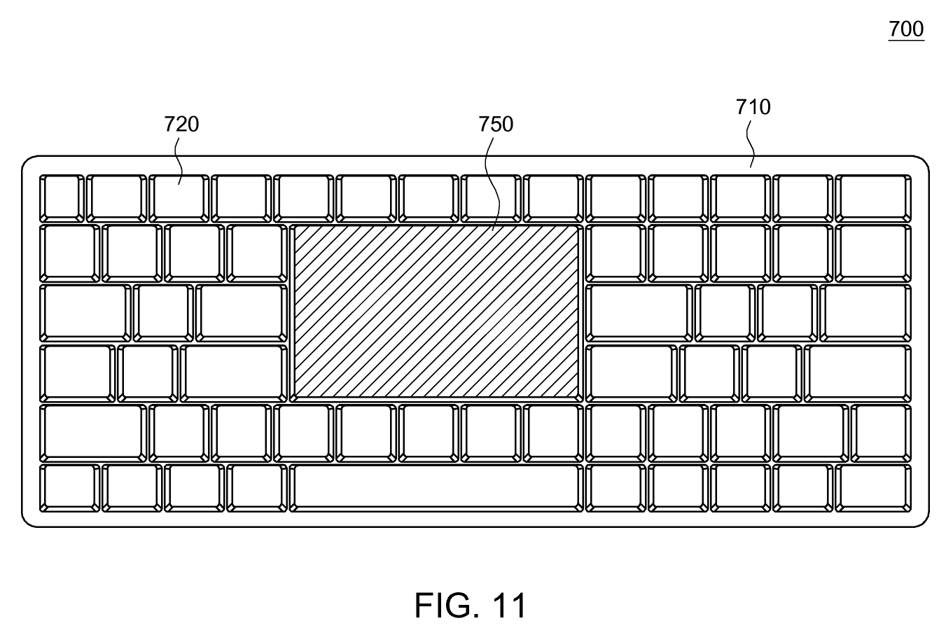

Referring to FIG. 11, a top view of an input device according to a seventh embodiment of the invention is shown. The input device 700 includes a base 710, a plurality of keys 720 and a touch panel 750. The keys 720 are disposed above the base 710. The touch panel 750 is disposed above the base 710 and located among the keys 720. Thus, the user can directly operate the touch panel 750 on the input device 700 in use without having to move between the input device 700 and the mouse reciprocally, hence saving the user's trouble in use and increasing the convenience of operation.

According to the input device disclosed in the above embodiments of the invention, the control unit automatically performs the first action or the second action according to the content of the pressing signal being received. That is, the user can perform the action of operating the touch panel on the input device or perform the action of keying in by pressing the key directly like typing. Thus, the user does not need to move between the keyboard and the mouse reciprocally, saving the user's trouble in use and providing the user with a multi-functional keyboard.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An input device, comprising:
a base;
a keyboard structure disposed above the base;
a touch panel disposed above the base and moving relative to the base upward and downward, wherein when the touch panel is touched by an object, the touch panel generates a touching signal;
a press-sensing element disposed between the base and the touch panel, wherein when the touch panel is pressed by the object, the press-sensing element generates a pressing signal; and
a control unit, wherein at the time that the control unit receives the pressing signal, the control unit performs a first action or a second action according to the content of the touching signal being received.

2. The input device according to claim 1, wherein the content of the touching signal being received comprise a moving distance for which the object is moved on the touch panel within a predetermined time, and the control unit performs the first action or the second action according to the content of the touching signal being received.

3. The input device according to claim 2, wherein the control unit, according to the content of the touching signal being received, determines whether the moving distance for which the object is moved on the touch panel within the predetermined time is larger than a predetermined distance, if yes, the control unit performs the first action, otherwise the control unit performs the second action.

4. The input device according to claim 3, wherein the predetermined time substantially is 1 second, and the predetermined distance substantially is 0.5 cm.

5. The input device according to claim 1, further comprising:
a pivot disposed on the base and connected to one end of the touch panel, wherein when the touch panel is pressed by the object, the touch panel swings relatively to the base upward and downward around the pivot, so that the press-sensing element generates the pressing signal.

6. The input device according to claim 1, further comprising:
a bar linkage disposed between the base and the touch panel, wherein the bar linkage comprise two rods coupled to each other, one end of each rod is coupled to the base, and the other end of each rod is disposed on the bottom surface of the touch panel, and when the touch panel is pressed by the object, the touch panel moves relatively to the base upward and downward by way of the bar linkage, so that the press-sensing element generates the pressing signal.

7. The input device according to claim 1, wherein the first action is clicking, and the second action is keying in.

8. The input device according to claim 1, wherein the keyboard structure comprises:
a plurality of keys, wherein the touch panel is disposed above the base and located among the keys.

9. The input device according to claim 1, wherein the keyboard structure comprises:
a plurality of keys, wherein the touch panel is disposed above one of the keys.

10. The input device according to claim 9, wherein the keyboard structure further comprises:
a plurality of pivots corresponding to the keys, wherein each pivot is disposed on the base and connected to one end of a corresponding key, and when the touch panel located on the key is pressed by the object, the touch panel and the key swing relatively to the base upward and downward around the pivot, so that the press-sensing element generates the pressing signal.

11. The input device according to claim 9, wherein the keyboard structure further comprises:
a plurality of bar linkages correspondingly disposed between the base and each key, wherein the bar linkage comprises two rods coupled to each other, one end of each rod is coupled to the base, the other end of each rod is disposed on the bottom surface of the key, and when the touch panel located on the key is pressed by the object, the key and the touch panel move relatively to the base upward and downward by way of the bar linkage, so that the press-sensing element generates the pressing signal.

12. An input device, comprising:
a base;
a plurality of keys disposed above the base; and
a touch panel disposed above the base and located among the keys.

13. An input device, comprising:
a keyboard structure comprising a base; and
a touch panel disposed at a part of the base.

14. The input device according to claim 13, wherein the base comprises an extension portion on which the touch panel is disposed.

15. The input device according to claim 13, further comprising: p1 a press-sensing element disposed between the base and the touch panel, wherein when the press-sensing element senses that the touch panel is touched by an object, the press-sensing element generates a pressing signal; and
a control unit, wherein at the time that the control unit receives the pressing signal, the control unit performs a first action or a second action according to the content of the touching signal being received.

16. The input device according to claim 15, wherein the content of the touching signal being received comprises a moving distance for which the object is moved on the touch panel within a predetermined time, and the control unit performs the first action or the second action according to the content of the touching signal being received.

17. The input device according to claim 15, wherein the control unit, according to the content of the touching signal being received, determines whether the moving distance for which the object is moved on the touch panel within the predetermined time is larger than a predetermined distance, if yes, the control unit performs the first action, otherwise the control unit performs the second action.

18. The input device according to claim 17, wherein the predetermined time substantially is 1 second, and the predetermined distance substantially is 0.5 cm.

19. The input device according to claim 15, wherein the first action is clicking, and the second action is keying in.

20. The input device according to claim 15, further comprising:
a pivot disposed on the base and connected to one end of the touch panel, wherein when the touch panel is pressed by the object, the touch panel swings relatively to the base upward and downward around the pivot, so that the press-sensing element generates the pressing signal.

21. The input device according to claim 15, further comprising:
a bar linkage disposed between the base and the touch panel, wherein the bar linkage comprises two rods coupled to each other, one end of each rod is coupled to the base, the other end of each rod is disposed on the bottom surface of the touch panel, and when the touch panel is pressed by the object, the touch panel moves relatively to the base upward and downward by way of the bar linkage, so that the press-sensing element generates the pressing signal.

22. The input device according to claim 15, wherein the keyboard structure comprises a plurality of keys, and the touch panel is disposed above the base and located among the keys.
